(19) United States
(12) Patent Application Publication
(10) Pub. No.: US 2017/0332062 A1
(43) Pub. Date: Nov. 16, 2017

(54) THERMAL DETECTING SYSTEM AND THERMAL DETECTING METHOD

(71) Applicant: RADIANT INNOVATION INC., HSINCHU CITY (TW)

(72) Inventors: YUNG-CHANG CHANG, HSINCHU COUNTY (TW); FENG-LIEN HUANG, HSINCHU CITY (TW)

(21) Appl. No.: 15/154,470

(22) Filed: May 13, 2016

(51) Int. Cl. H04N 9/82; H04N 5/232; G01J 5/08; H04M 1/02; G01J 5/10; G01J 5/00

(52) U.S. Cl. CPC H04N 9/8205; H04N 5/23293; H04N 5/23203; H04M 1/0266; G01J 5/0896; H04M 1/0264; G01J 5/10; G01J 2005/0077

(57) ABSTRACT

A thermal detecting system and a thermal detecting method are provided. The thermal detecting method includes the steps of: measuring the temperature of an object by a temperature measuring device for obtaining a measurement information of the object; capturing an image which includes the object by a portable electronic device; transmitting the measurement information to the portable electronic device; and attaching or storing the measurement information to the image.

### BACKGROUND

1. Technical Field

The present disclosure relates to a thermal detecting device and a thermal detecting method, in particular, to a thermal detecting device and a thermal detecting method that may be used in cooperation with a portable electronic device.

2. Description of Related Art

The infrared thermometers in the prior art only have the function of measuring temperature. When a user intends to measure the temperature of an object, there is a need to aim the infrared sensor on an infrared thermometer to the object for obtaining the current temperature of the object. The measured temperature will be displayed on the screen of the infrared thermometer.

However, in the use of the above thermometer, the previous measured temperature will be replaced by the temperature measured afterward during a continuous measurement. In addition, even if the infrared thermometer in the prior art has a data storing unit arranged therein, the data storing unit may only record the temperature that has been measured, rather than the object that has been measured.

In addition, the existing portable electronic devices (such as smart phones or tablets) have more and more functions, for instance, these portable electronic devices may be used to capture images (such as taking pictures or recording videos) and are able to perform imaging processing technique (such as panorama or image overlapping technique). Therefore, incorporating the infrared thermometers into the portable electronic devices may increase the efficiency of the electronic devices and expand the application of the infrared thermometers.

In sum, the problem that needs to be solved is to provide a thermal detecting device and a thermal detecting method that may be used in cooperation with portable electronic devices for overcoming the above disadvantages.

### SUMMARY

The problem to be solved by the instant disclosure is to provide a thermal detecting device and a thermal detecting method that may be used with portable electronic devices.

To solve the above problem, an exemplary embodiment of the instant disclosure provides a thermal detecting system comprising a temperature measuring device and a portable device. The temperature measuring device includes a temperature measuring unit, a processing unit electrically connected to the temperature measuring unit, a moisture sensing unit electrically connected to the processing unit and a measurement information transmitting unit electrically connected to the processing unit. The portable electronic device is connected to the temperature measuring device through wire or wireless connection, the portable electronic device includes a signal transmitting unit, a controlling unit electrically connected to the signal transmitting unit and an image capturing unit electrically connected to the controlling unit. The temperature measuring unit measures the temperature of an object for providing a signal measurement value to the processing unit to output a measurement information corresponding to the signal measurement value, the measurement information is transmitted to the signal transmitting unit through the measurement information transmitting unit. The image capturing unit captures an image including the object, the controlling unit displays the measurement information of the object on the image to form a picture or a scene including the measurement information of the object.

Another exemplary embodiment of the instant disclosure provides a thermal detecting method comprising the steps of: measuring the temperature of an object by a temperature measuring device for obtaining a measurement information of the object; capturing the object by a portable electronic device for obtaining an image including the object; transmitting the measurement information to the portable electronic device; and attaching or storing the measurement information to the image.

Yet another exemplary embodiment of the instant disclosure further provides a thermal detecting method comprising the steps of: sequentially measuring the temperatures of a plurality of objects by moving a temperature measuring device for obtaining a plurality of measurement information of the plurality of objects respectively, and simultaneously emitting a marking light aiming or surrounding the objects for sequentially targeting the plurality of objects; driving a portable electronic device to timingly capturing an image including the plurality of objects for obtaining a plurality of images; transmitting a plurality of measurement information to the portable electronic device; attaching or storing a plurality of measurement information to the plurality of images respectively; and combining the plurality of images for presenting a picture or a scene including the plurality of measurement information.

The advantages of the instant disclosure is that, in the thermal detecting system and thermal detecting method, by utilizing the signal connection in wired or wireless form between the temperature measuring device and the portable electronic device, the measurement information detected by the temperature measuring device may be transmitted to the portable device; and by capturing the image of the measured object by the imaging capturing unit in the portable device and overlapping the image and the measurement information by the portable device, a picture or a scene is able to be presented including both the measurement information and the image. In addition, by image synthesis technique, a plurality of images are able to be combined including a plurality of measurement information into a picture or a scene to obtain a picture including the measurement information of each object. A temperature distribution curve may be present at the same time.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a three-dimensional schematic view of the thermal measuring device provided by a first embodiment of the instant disclosure.

FIG. 2 is another three-dimensional schematic view of the thermal measuring device provided by the first embodiment of the instant disclosure.

FIG. 3 is the function block diagram of the thermal measuring device provided by the first embodiment of the instant disclosure.

FIG. 4 is a function block diagram of the portable electronic device provided by the first embodiment of the instant disclosure.

FIG. 5 is a module function block diagram of the temperature measuring unit provided by the first embodiment of the instant disclosure.

FIG. 6 is a flow chart of one of the thermal detecting methods provided by a second embodiment of the instant disclosure.

FIG. 7 is a schematic view of the use the thermal detecting method provided by the second embodiment of the instant disclosure.

FIG. 8 is a picture or a scene including both the measurement information and the image presented by the portable electronic device provided by the second embodiment of the instant disclosure.

FIG. 9 is a flowchart of one of the thermal detecting methods provided by a third embodiment of the instant disclosure.

FIG. 10 is a schematic view while using the thermal detecting method provided by the third embodiment of the instant disclosure.

FIG. 11 is another schematic view while using the thermal detecting method provided by the third embodiment of the instant disclosure.

FIG. 12 is yet another schematic view while using the thermal detecting method provided by the third embodiment of the instant disclosure.

FIG. 13 is a picture or a scene including a plurality of measurement information presented by the portable electronic device provided by the third embodiment of the instant disclosure.

FIG. 14 is a flowchart of another thermal detecting method provided by the third embodiment of the instant disclosure.

FIG. 15 is another picture or a scene including a plurality of measurement information presented by the portable electronic device provided by the third embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

### First Embodiment

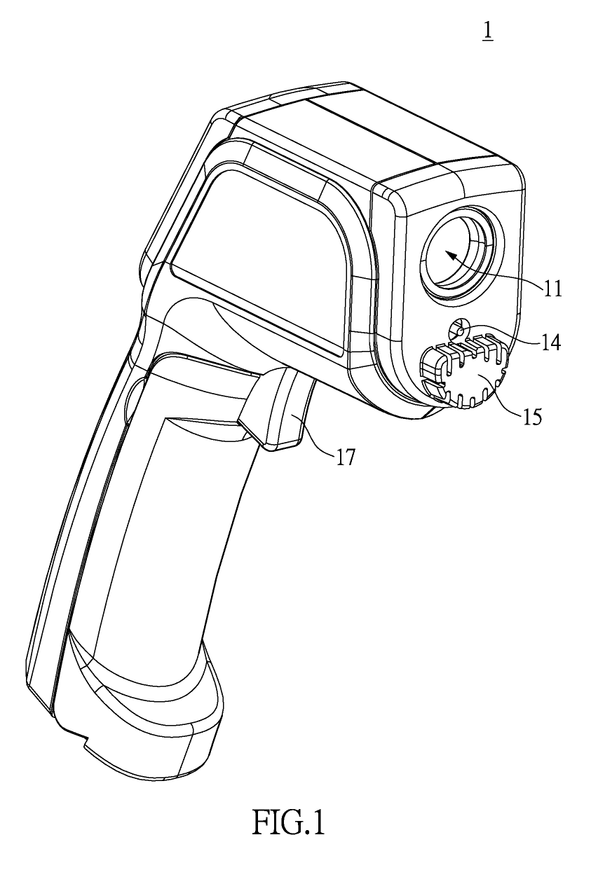

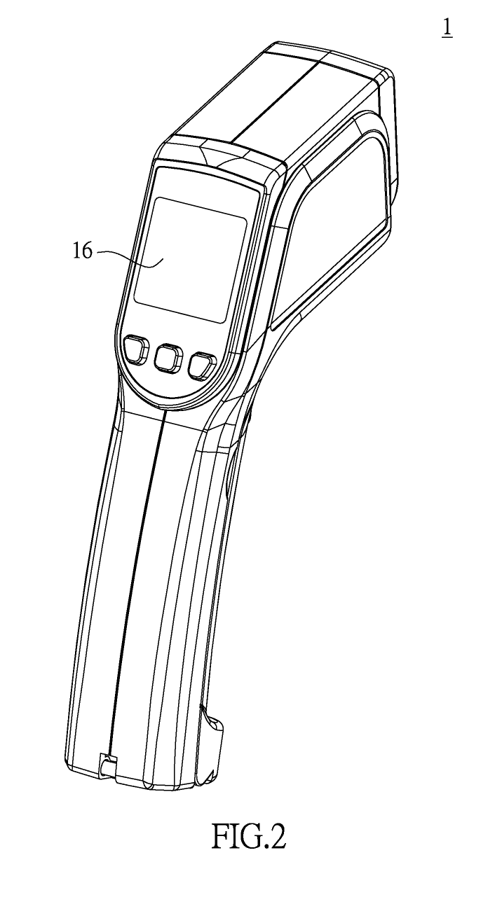

Please refer to FIG. 1 to FIG. 4. The instant disclosure provides a thermal detecting system S for obtaining the temperature of an object. The thermal detecting system S includes a temperature measuring device 1 and a portable electronic device 2. The portable electronic device 2 may electrically connect to the temperature measuring device 1 in wired or wireless manner. For instance, the portable electronic device 2 may be a smart phone or a tablet, and the temperature measuring device 1 may be a radiation pyrometer, an optical pyrometer or an infrared thermometer. However, the instant disclosure is not limited thereto.

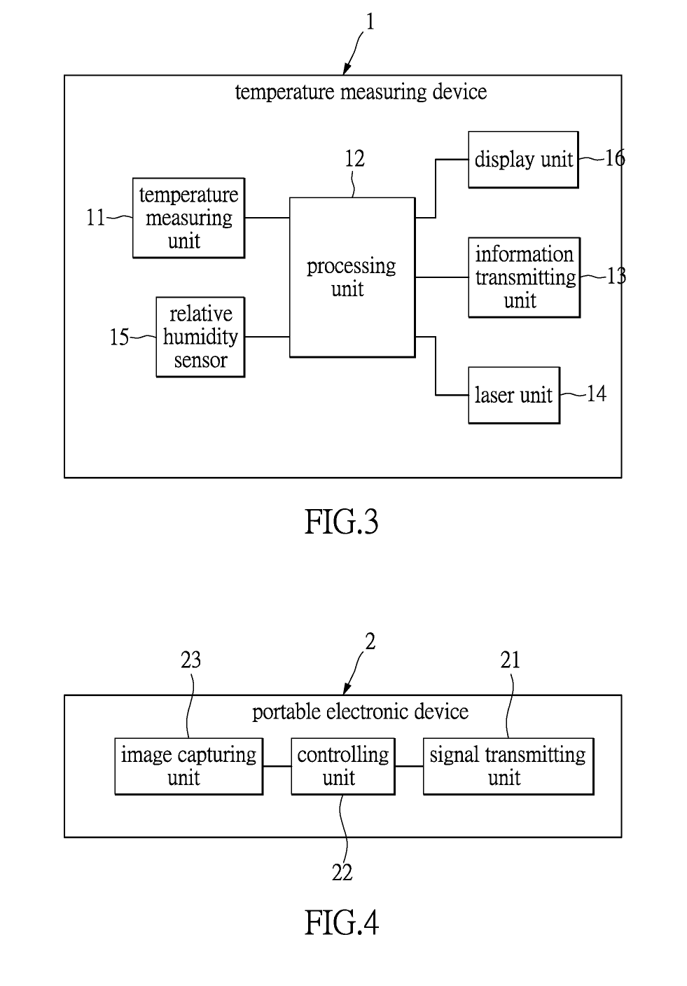

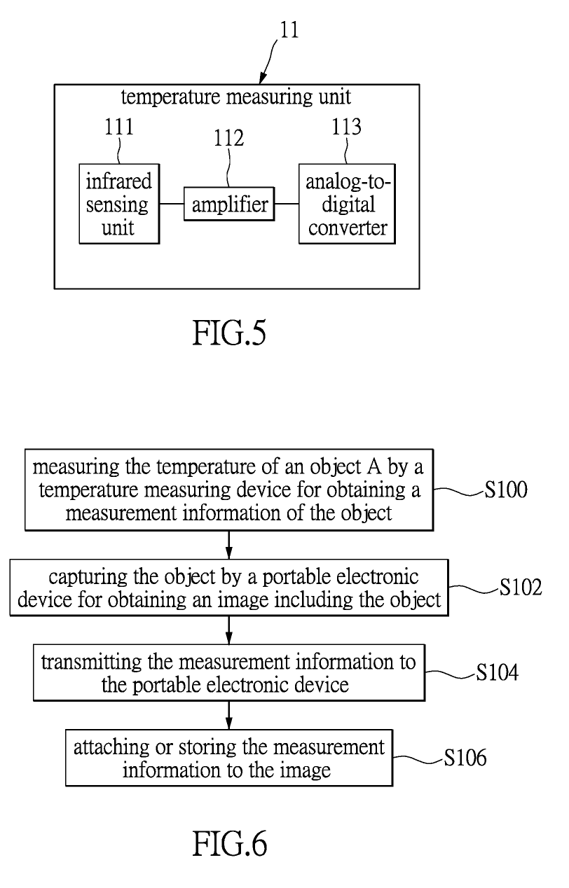

Please refer to FIG. 3. The temperature measuring device 1 includes a temperature measuring unit 11, a processing unit 12 electrically connected to the temperature measuring unit 11, and a measurement information transmitting unit 13 electrically connected to the processing unit 12. For instance, as shown in FIG. 5, if the temperature measuring unit 11 is an infrared thermometer, the temperature measuring unit 11 may include an infrared sensing unit 111, an amplifier 112 and an analog-to-digital converter 113. It is worthwhile to mention that the processing unit 12 may be a microcontroller unit (MCU). However, the instant disclosure is not limited thereto. In addition, in another embodiment, the amplifier 112 and the analog-to-digital converter 113 may be arranged in the processing unit 12, and hence, the processing unit 12 may be an application-specific integrated circuit (ASIC), i.e., the temperature measuring unit 11 is the infrared sensing unit 111. In another embodiment, the temperature measuring device 1 may be a radiation pyrometer sensing unit, and the instant disclosure is not limited thereto.

In addition, preferably, the temperature measuring device 1 further includes a laser unit 14 electrically connected to the processing unit for emitting a marking light 141 (such as a laser light 141 generated by the laser unit 14) aiming or surrounding the object. The marking light 141 may also be used to explicitly show the detecting area to be measured. For instance, the path of the marking light 141 may be substantially parallel to the sensing path of the temperature measurement unit 11 for targeting the detecting area to be measured. In other words, the laser unit 14 may emit a single laser beam or a plurality of laser beams, and the single marking light 141 may aim at the object to be measured by moving the temperature measuring device 1. In addition, in other embodiments, a plurality of marking light beams may be output by arranging a plurality of laser units 14 or by arranging a spectroscope in combination with a laser unit 14, and the plurality of marking light 141 surround a detecting area. In other words, the detecting area is substantially the area being currently measured by the temperature measurement unit 11. It is worthwhile to mention that in other embodiments, the range of the detecting area could be more definite by arranging more marking light beams. Furthermore, in another embodiment, the laser unit 14 may be substituted by other light sources to form the corresponding marking light 141.

When the user presses on an activation unit 17 electrically connected to the processing unit 12 in the temperature measuring device 1, a driving measurement signal may be initiated and transmitted to the processing unit 12, and the processing unit 12 may transmit a measurement activation signal to the infrared sensing unit 111 according to the driving measurement signal. The infrared sensing unit 111 performs the infrared signal temperature measurement according to the activation signal for transforming infrared light into a voltage signal. The voltage signal is amplified by the amplifier 112, then transformed into a measurement information digital signal (for example, infrared signal measurement information) by the analog-to-digital converter 113, and transmitted to the processing unit 12. Next, the measurement information may be transmitted to the portable electronic device 2 by the measurement information transmitting unit 13.

In addition, in other embodiments, the temperature measuring device 1 may further include a relative humidity sensor 15 electrically connected to the processing unit 12. For instance, the relative humidity sensor 15 may be used to detect a dry bulb temperature, a wet bulb temperature, a dew point temperature or a relative moisture. Therefore, the dry bulb temperature, the wet bulb temperature, the dew point temperature or the relative moisture may be transmitted to the portable electronic device 2 through the measurement information transmitting unit 13. In other words, the measurement information is not limited to a temperature measurement value, and may further comprise a dry bulb temperature value, a wet bulb temperature value, a dew point temperature value or a relative moisture value.

In addition, the temperature measuring device 1 may further include a display unit 16 that may be electrically connected to the processing unit 12 for displaying the temperature currently measured by the temperature measuring unit 11. In addition, the display unit 16 can be used to show other information such as moisture information. In other words, the measurement information can be displayed on the display unit 16 of the temperature measuring device 1, and can be transmitted to the portable device 2.

Please refer to FIG. 4. The portable electronic device 2 includes a signal transmitting unit 21, a controlling unit 22 electrically connected to the signal transmitting unit 21 and an image capturing unit 23 electrically connected to the controlling unit 22. The measurement information can be transmitted to the signal transmitting unit 21 of the portable electronic device 2 by the measurement information transmitting unit 13. In addition, for instance, the measurement information transmitting unit 13 and the signal transmitting unit 21 can form a wireless transmitting module, for example, a blue tooth module. In addition, the information transmitting unit 13 and the signal transmitting unit 21 can be a wire transmitting module, for example, a 4-pin audio jack connector connected to the portable electronic device 2 by wire, such as an earphone microphone interface. It is worthwhile to mention that the instant disclosure is not limited to wired transmitting modules or wireless transmitting modules.

Next, the image capturing unit 23 captures an image I (predetermined capturing range) including an object, i.e., the image I is an image that is captured by the image capturing unit 23 and shown on the screen of the portable electronic device 2. Next, the controlling unit 22 shows the measurement information of the object on the image I captured by the image capturing unit 23 for forming a picture P (or scene) including the measurement information of the object. In other words, the temperature measuring device 1 does not include the image capturing unit 23. The image is captured by the image capturing unit 23 on the portable electronic device 2. The specific thermal detecting method will be discussed later.

### Second Embodiment

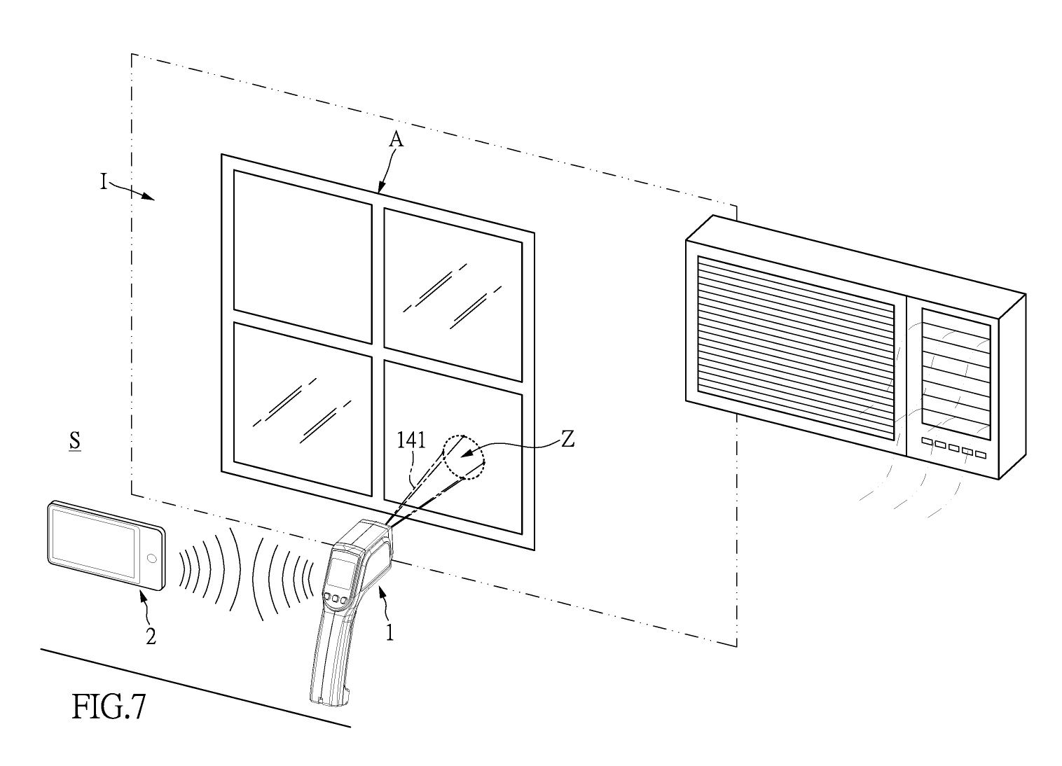

First, please refer to FIG. 6 and FIG. 7, and refer to FIG. 3 and FIG. 4 as needed. FIG. 6 is a flow chart of one of the thermal detecting methods provided by a second embodiment of the instant disclosure, and FIG. 7 is a schematic view of the use of the thermal detecting method provided by the second embodiment of the instant disclosure. The second embodiment of the instant disclosure provides a thermal detecting method including the following steps. As shown in step S100, measuring the temperature of an object A by a temperature measuring device 1 for obtaining a measurement information of the object A. In other words, the temperature measuring unit 11 can be used to measure the object A to obtain the measurement information. For instance, the temperature measuring device 1 can be a conventional thermometer having temperature measuring function, preferably a contactless temperature measuring device 1. It is worthwhile to mention that the temperature measuring device 1 has a measurement information transmitting unit 13 having an information transmitting function for transmitting the measurement information of an object A to an external receiver (such as the portable electronic device 2). Preferably, the temperature measuring device 1 further includes a laser unit 14 for emitting a marking light 141 aiming or surrounding the object A. In addition, the marking light 141 may project on the object A in a flickering manner to enhance the visibility of the detecting area. In other embodiments, the flickering is of benefit to the image processing process afterward. In addition, the object A mentioned herein may also refer to the detecting area to be measured.

Next, as shown in step S102, capturing the object A by a portable electronic device 2 for obtaining an image I (predetermined capturing range) including the object A. The image capturing unit 23 on the portable electronic device 2 may be used to capture the image that may be captured by the image capturing unit 23 and may be displayed on the screen of the portable electronic device 2. In other words, the image capturing unit 23 may be a camera module in the portable electronic device 2.

Please refer to FIG. 7. The signal transmittance between the portable electronic device 2 and the temperature measuring device 1 may be achieved by utilizing an application in the portable electronic device 2, and utilizing the signal transmitting unit 21 of the portable electronic device 2 in conjunction with the measurement information transmitting unit 13 in the temperature measuring device 1. The user may hold the portable electronic device 2 in one hand, holding the temperature measuring device 1 in the other hand, using the laser unit 14 on the temperature measuring device 1 to emit the marking light 141 on the object A, and simultaneously using the marking light 141 to surround the detecting area Z to be measured on the object A. In addition, it is worthwhile to mention that the portable electronic device 2 may be fixed on the temperature measuring device 1 by a supporting frame (not shown) arranged on the temperature measuring device 1, thereby correspondingly arranging the temperature measuring device 1 and the portable electronic device 2. Therefore, the image I captured by the image capturing unit 23 may continue to cover the marking light 141 projected on the object A by the laser unit 14.

When the user presses on the activation unit 17, the temperature measuring device 1 may be initiated and start to measure the temperature of the object A to obtain measurement information of the object A. During the same time, the portable electronic device 2 may capture an image I including the object A. In addition, the laser unit 14 can emit the marking light 141 after the user presses on the activation unit 17, and measure the temperature of the object A while emitting the marking light 141 to obtain the measurement information. The image I is captured by the image capturing unit 23 at the same time. In other words, the step of measuring the temperature of the object A by the temperature measuring device 1 and the step of capturing the object A by the portable electronic device 2 are performed simultaneously. However, the instant disclosure is not limited thereto. For instance, in other embodiments, a marking light 141 may be first emitted, and after a predetermined time, the temperature of the object A may be measured and the image I may be captured when the user targets the area to be measured.

Next, as shown in step S104, transmitting the measurement information to the portable electronic device 2. For instance, using the signal transmitting unit 21 in the portable electronic device 2 and the measurement information transmitting unit 13 to transmit the measurement information measured by the temperature measuring device 1 to the portable electronic device 2. Therefore, the information transmitting unit 13 may transmit the measurement information to the controlling unit 22 of the portable electronic device 2 for further processing.

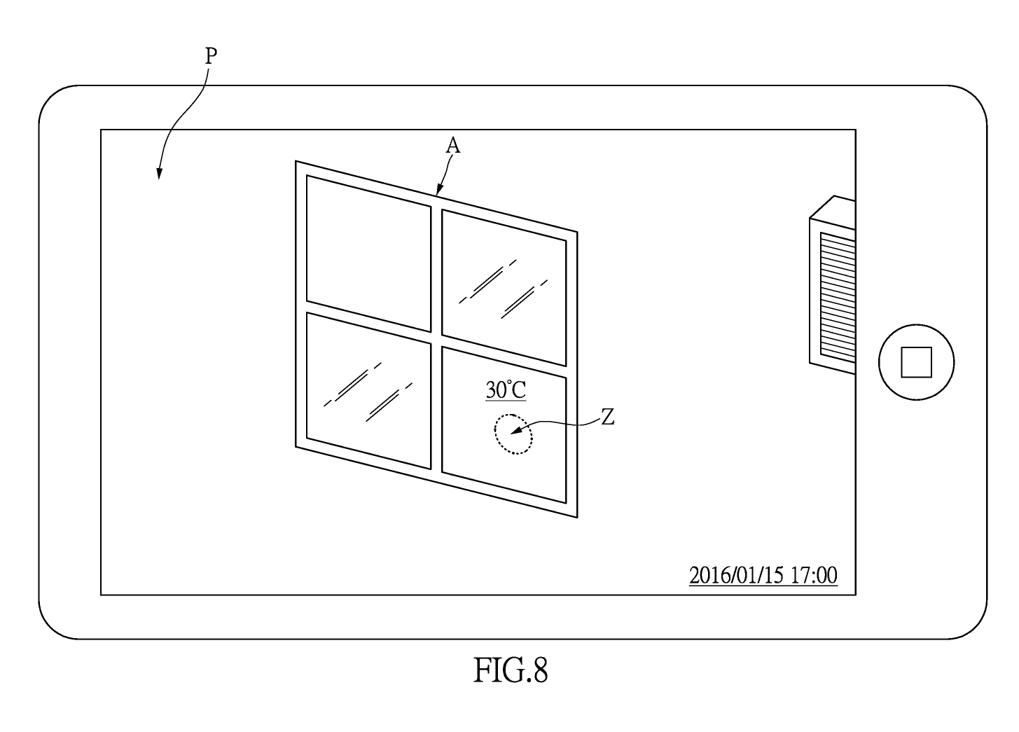

Next, please refer to FIG. 8. FIG. 8 is a picture or a scene including the measurement information and the image presented by the portable electronic device provided by the second embodiment of the instant disclosure. To be specific, as shown in step S106, attaching or storing the measurement information to the image I. In step S106, the measurement information of the object A (the 30° C. shown in the figure) is displayed on the image I captured by the portable device 2 to present a picture P (or scene) including the measurement information and the image I. Preferably, when the measurement information is displayed in the image I, the measurement information may be positioned adjacent to the marking light 141 or the object A. However, in other embodiments, the measurement information may be directly displayed in the detecting area Z surrounded by the marking light 141. However, the instant disclosure is not limited thereto. In other words, in the instant disclosure, the measurement information may be adjacent to the detecting area Z.

The step of attaching or storing the measurement information to the image I is able to perform the image processing technique by the controlling unit 22 in the portable electronic device 2, i.e., identifying the captured image I by the controlling unit 22 or the application in the portable electronic device 2 to judge the position of the marking light 141 in the image I first, and positioning the measurement information (such as temperature or moisture information) adjacent to the marking light 141 or the detecting area Z, or in the detecting area Z. In addition, in the step of attaching or storing measurement information to image I, the measurement information does not have to be directly displayed in the image, i.e., the measurement information and the image I are overlapped with each other. In addition, the measurement information and the image may be stored as digital information in a digital manner, i.e., instead of directly displaying the measurement information in the image I, the measurement information may be attached or stored in the image I by data communication. In addition, the date, time, etc. of the current measurement can be added into the image I to record the object being measured and the date and time of the measurement. Afterward, the picture P (or scene) being presented may be stored in the storing unit (not shown) in the electronic device 2 for further use.

Furthermore, if the marking light 141 is emitted in a flicking manner during which the marking light 141 is on and off under a predetermined frequency, the shutter time of the image capturing unit 23 may be adjusted, and hence, the image capturing unit 23 will continuously capture the image I. In other words, the image capturing unit 23 may capture images in which a marking light 141 is or is not projected on the object A. Therefore, the image processing process performed afterward could be easier.

### Third Embodiment

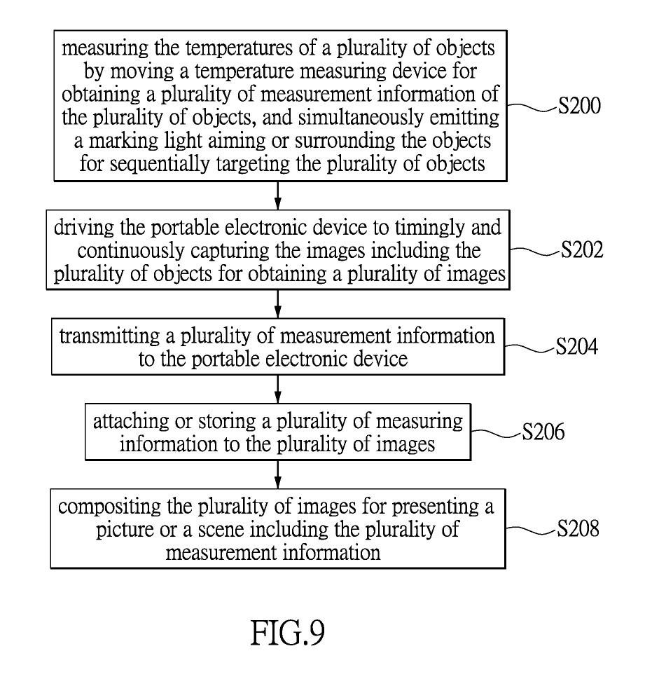

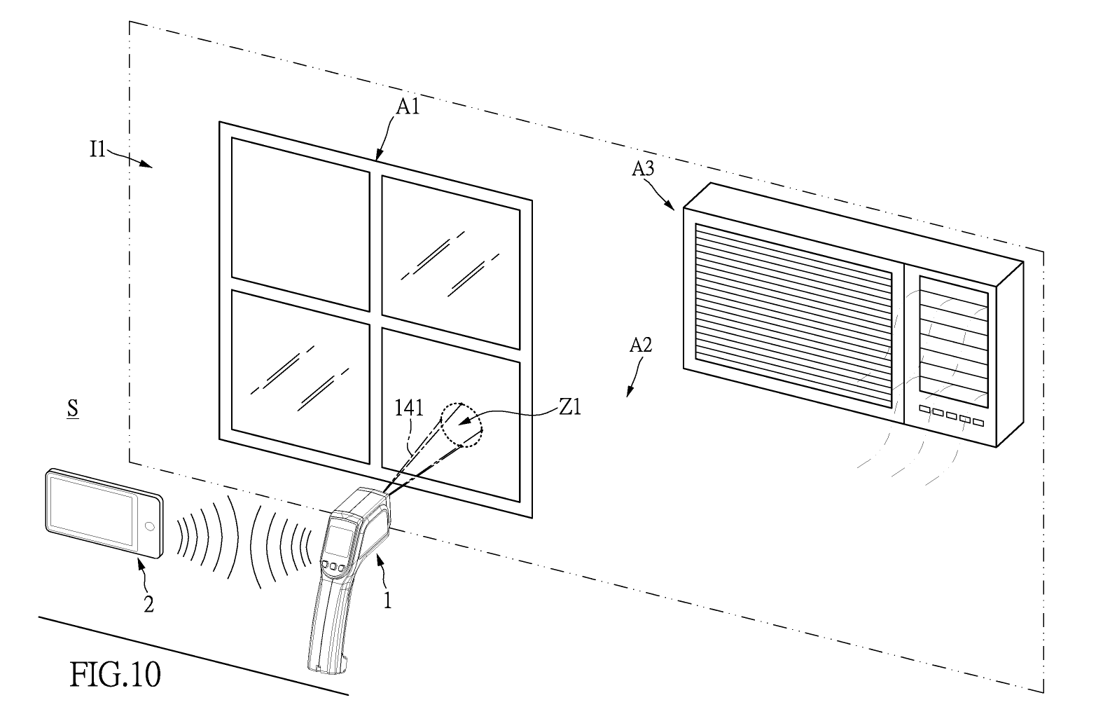

First, please refer to FIG. 9, FIG. 3 and FIG. 4. FIG. 9 is a flowchart of one of the thermal detecting methods provided by a third embodiment of the instant disclosure. In addition, please refer to FIG. 10 to FIG. 12 as needed. The third embodiment of the instant disclosure provides a thermal detecting method. The major difference between the third embodiment and the second embodiment is that the picture P (or scene) formed in the third embodiment may contain the measurement information of a plurality of objects (A1, A2, A3) respectively, similar to a function provided by a thermal imager. In other words, the application in the portable electronic device 2 may have a different measuring mode corresponding to a different thermal detecting method.

To be specific, the thermal detecting method provided by the third embodiment includes the following steps. As shown in step S200, measuring the temperatures of a plurality of objects (A1, A2, A3) by moving (or rotating) a temperature measuring device 1 for obtaining a plurality of measurement information (of each object) of the plurality of objects (A1, A2, A3), and simultaneously emitting a marking light 141 aiming or surrounding the objects (A1, A2, A3) for sequentially targeting the plurality of objects (A1, A2, A3). To be specific, when switching to an adequate measuring mode, the user may continuously press on the activation unit 17 on the temperature measuring device 1 to generate a driving measurement signal and continue measuring. Meanwhile, while continuously pressing on the activation unit 17, the user moves the temperature measuring device 1 to measure the temperatures of the plurality of objects (A1, A2, A3) respectively. During the process of measuring the temperatures of the plurality of objects (A1, A2, A3), the time for generating the two adjacent measurement data may be spaced from each other for a predetermined time interval which is predetermined by the temperature measuring device 1 or may be set by the user.

Next, as shown in step S202, timingly capturing images (I1, I2, I3) continuously (there is a predetermined time interval between capturing each image by the image capturing unit 23) including a plurality of objects (A1, A2, A3) by driving a portable electronic device 2 for obtaining a plurality of images (I1, I2, I3) of the plurality of objects (A1, A2, A3). The portable electronic device 2 may continuously take the images (I1, I2, I3) in a predetermined range, i.e., the images (I1, I2, I3) comprising an image area including the objects (A1, A2, A3) to be measured. In addition, capturing the objects (I1, I2, I3) continuously means that there is a predetermined time interval between capturing each image by the image capturing unit 23, in which the predetermined time interval may be set by the user through the application or may be a predetermined time set in advance by the portable electronic device 2, for example, the predetermined time interval may be the shutter time of the portable electronic device 2.

Preferably, the step (S200) of sequentially measuring the temperatures of a plurality of objects (A1, A2, A3) by moving the temperature measuring device 1 for obtaining a plurality of measurement information of the plurality of objects (A1, A2, A3) respectively, and simultaneously emitting a marking light 141 aiming or surrounding the objects (A1, A2, A3) for targeting the plurality of objects (A1, A2, A3), and the step (S202) of driving the portable electronic device 2 to timingly and continuously capturing the images (I1, I2, I3) including the plurality of objects (A1, A2, A3) for obtaining a plurality of images (I1, I2, I3) are performed simultaneously. In addition, in the third embodiment, the image capturing unit 23 will not move with the temperature measuring device 1. In other words, the temperature measuring device 1 is a movable member and the portable electronic device 2 is a fixed member.

Please refer to FIG. 10 to FIG. 12. FIG. 10 to FIG. 12 are schematic views while using the thermal detecting method provided by the third embodiment of the instant disclosure for measuring the first object A1, the second object A2 and the third object A3. To be specific, as shown in FIG. 10, the user may first move the temperature measuring device 1 to a predetermined position (the first position) and drive the temperature measuring device 1 to emit a marking light 141 aiming or surrounding the first object A1. The marking light 141 may form a first detecting area Z1 to be measured around the first object A1. Meanwhile, driving the temperature measuring device 1 to measure the first object A1 for obtaining the measurement information of the first object A1. Furthermore, during the measurement of the first object A1, the portable electronic device 2 is able to be simultaneously driven to capture the images including the first object A1, the second object A2 and the third object A3 for obtaining a first image I1 including the first object A1, the second object A2 and the third object A3. In other words, the first image I1 may also include the marking light 141 aiming or surrounding the first object A1.

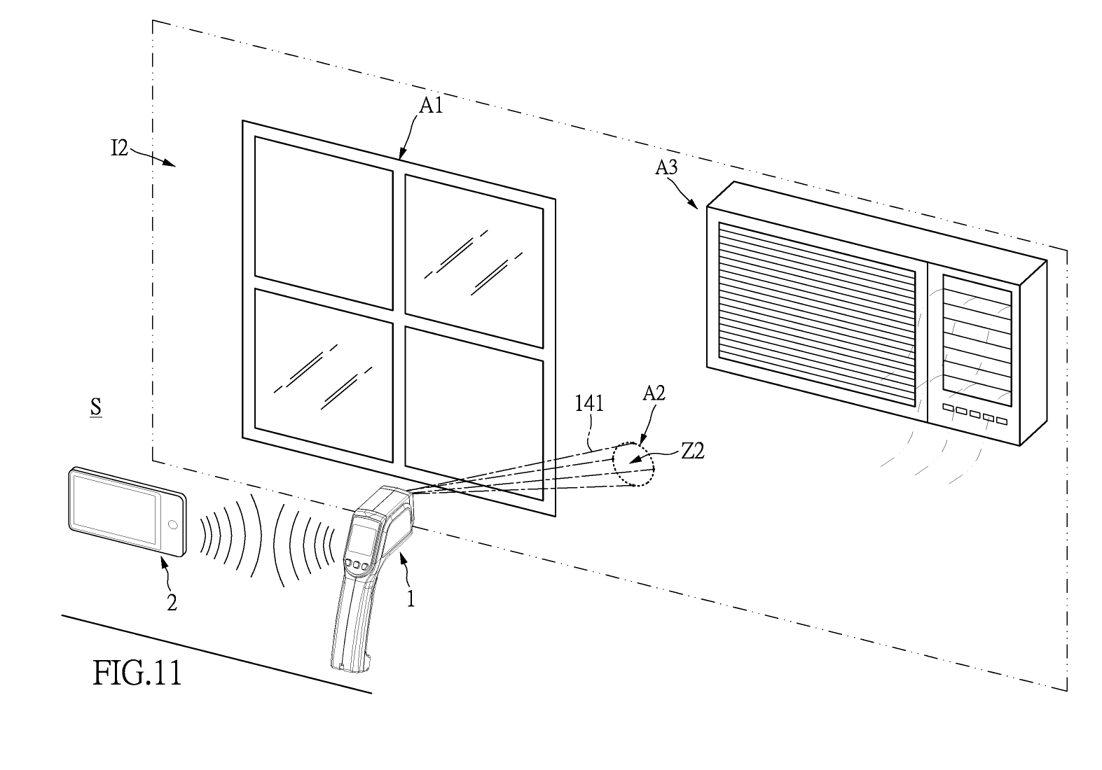

As shown in FIG. 11, the user may move (or rotate) the temperature measuring device 1 to the next position (the second position) and drive the temperature measuring device 1 to emit the marking light 141 aiming or surrounding a second object A2 and to measure the second object A2 for obtaining the measurement information of the second object A2. In addition, during the measurement of the second object A2, the portable electronic device 2 is able to be driven to capture an image including the first object A1, the second object A2 and the third object A3 for obtaining a second image I2 including the first object A1, the second object A2 and the third object A3. In other words, the second image I2 may include the marking light 141 which aims or surrounds the second object A2.

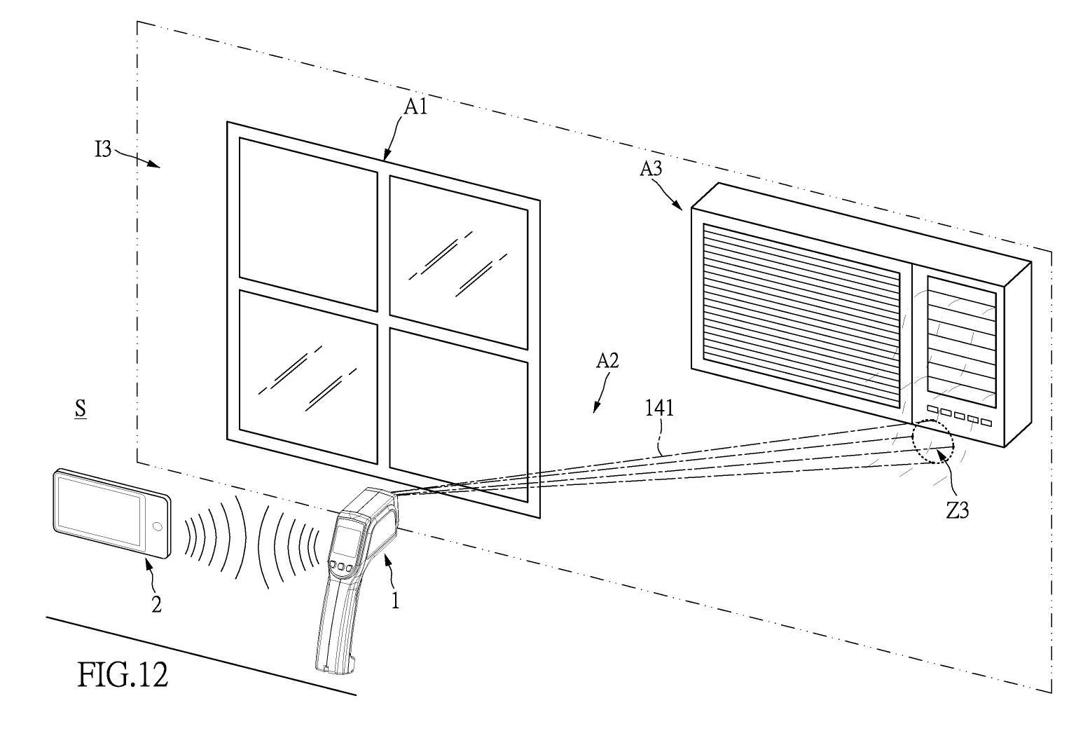

As shown in FIG. 12, the user may move (or rotate) the temperature measuring device 1 to the next position (the third position) and drive the temperature measuring device 1 to emit the marking light 141 aiming or surrounding a third object A3 and to measure the third object A3 for obtaining the measurement information of the third object A3. In addition, during the measurement of the third object A3, the portable electronic device 2 is able to be driven to capture an image including the first object A1, the second object A2 and the third object A3 for obtaining a third image I3 including the first object A1, the second object A2 and the third object A3. In other words, the third image I3 may include the marking light 141 which aims or surrounds the third object A3.

In addition, for ensuring that the image capturing unit 23 captures the objects (A1, A2, A3) to be measured, the image capturing unit 23 is able to adjust the shutter time during capturing the images (I1, I2, I3), i.e., to adjust the predetermined interval between capturing each image (I1, I2, I3) for capturing more images. In other words, the number of images captured by the image capturing unit 23 is determined by the moving speed of the temperature measuring device 1 in a predetermined moving distance (rotating distance) carried out by the user. The slower the temperature measuring device 1 is moved, the more images that may be captured. In contrast, the faster the temperature measuring device 1 is moved, the fewer images that may be captured. In addition, for performing the image processing step (image synthesis), the first image I1, the second image I2 and the third image I3 include substantially the same content and only differ from each other in that each image (I1, I2, I3) includes the marking light 141 projected at different positions for forming different detecting areas (Z1, Z2, Z3).

Next, as shown in step S204, transmitting a plurality of measurement information to the portable electronic device 2. To be specific, the temperature measuring device 1 may separately transmit the measurement information of the first object A1 (the 30° C. shown in the figure), the measurement information of the second object A2 (the 25° C. shown in the figure) and the measurement information of the third object A3 (the 20° C. shown in the figure) to the portable electronic device 2. In addition, for instance, the plurality of measurement information may be transmitted to the portable electronic device 2 at the moment that they are obtained, i.e., the measurement information of the first object A1 may be transmitted to the portable electronic device 2 immediately. In addition, the measurement information may be stored in the temperature measuring device 1 until the objects to be measured (A1, A2, A3) are measured, and all of the measurement information is transmitted to the portable electronic device 2. However, the instant disclosure is not limited thereto. In other words, in case all of the measurement information is transmitted to the portable electronic device 2 at once after all the objects to be measured (A1, A2, A3) are measured, when the user releases the activation unit 17 (ending the measuring mode), a stopping measurement signal may be sent to the processing unit 12 and the processing unit 12 may transmit all of the measurement information to the portable electronic device 2 according to the stopping measurement signal.

Next, as shown in step S206, attaching or storing a plurality of measuring information to the plurality of images (I1, I2, I3). To be specific, since each object (A1, A2, A3) has its own measurement information, the controlling unit 22 may attach the measurement information of each object to the corresponding images (I1, I2, I3). The means for attaching or storing the measurement information to the images are described in the second embodiment, and are not described again here.

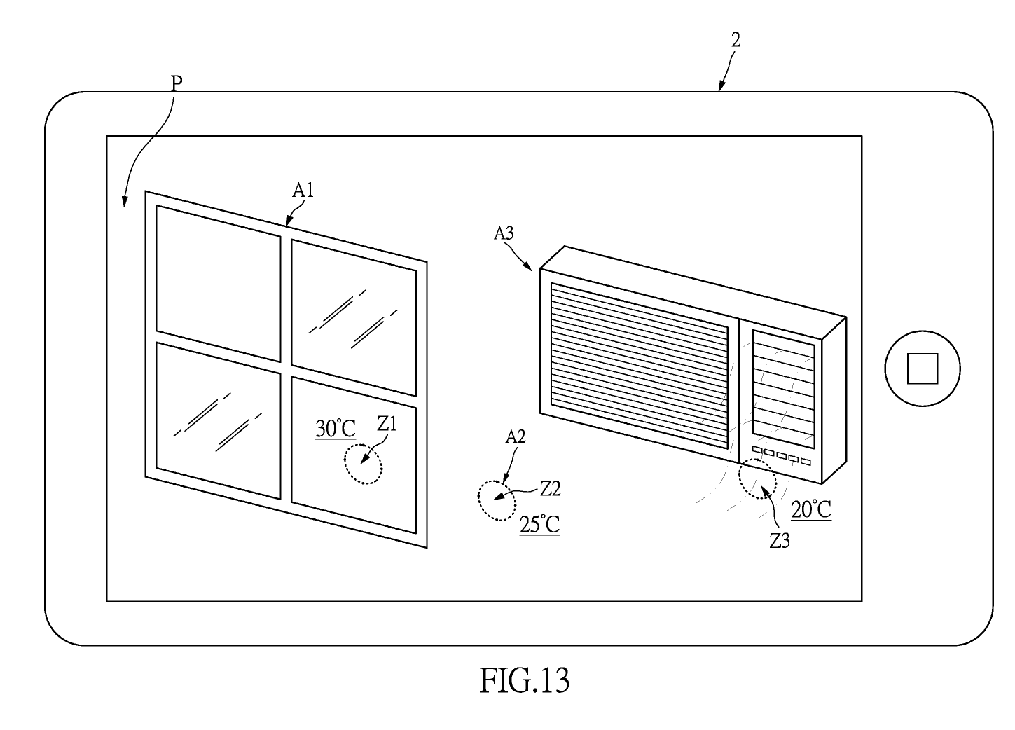

Next, please refer to FIG. 13. FIG. 13 is a picture P (or a scene) including a plurality of measurement information presented by the portable electronic device 2 provided by the third embodiment of the instant disclosure. In addition, as shown in step S208, combining a plurality of images (I1, I2, I3) to present a picture P (or a scene) including a plurality of measurement information. To be specific, the portable electronic device 2 may be used to perform image processing for overlapping the plurality of images (I1, I2, I3) captured in the previous step into a picture P (or a scene). It is worthwhile to mention that the means for combining a plurality of images (I1, I2, I3) may be carried out by determining the contrast ratio or sharpness of each image by the portable electronic device 2 and combining (ovelapping) the plurality of images into one picture. Therefore, a picture including a plurality of information of the plurality of objects (A1, A2, A3) is able to be presented. In other words, the presented picture P (or scene) may include the first detecting area Z1 formed by projecting the marking light 141 on the first object A1, the second detecting area Z2 formed by projecting the marking light 141 on the second object A2, and the third detecting area Z3 formed by projecting the marking light 141 on the third object A3. Meanwhile, the positions adjacent to each detecting area (Z1, Z2, Z3) show the corresponding measurement information of each detecting area (Z1, Z2, Z3). In other words, the plurality of measurement information may be displayed in the picture P (or the scene), and the plurality of measurement information is displayed adjacent to the corresponding marking light 141, the corresponding object (A1, A2, A3) or the corresponding detecting area (Z1, Z2, Z3).

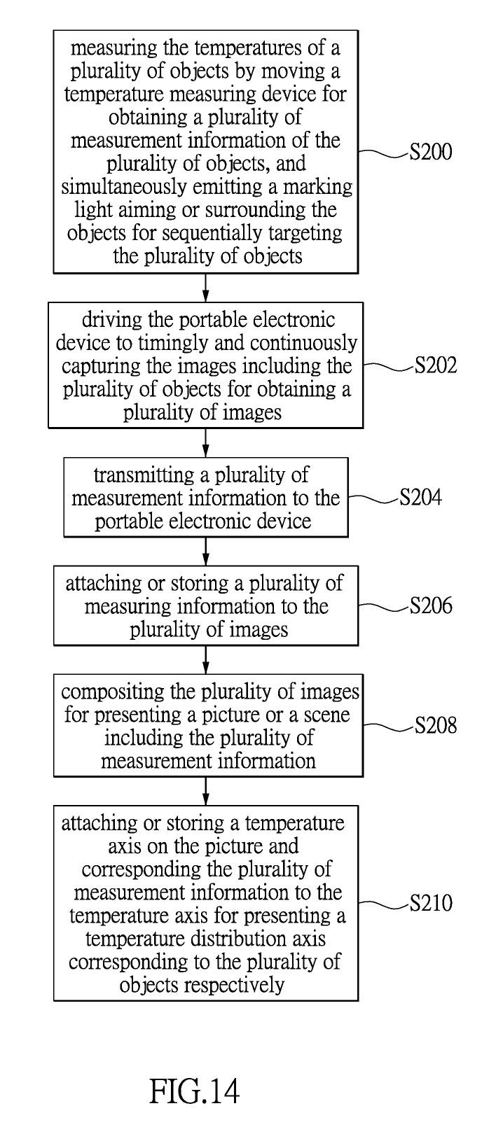

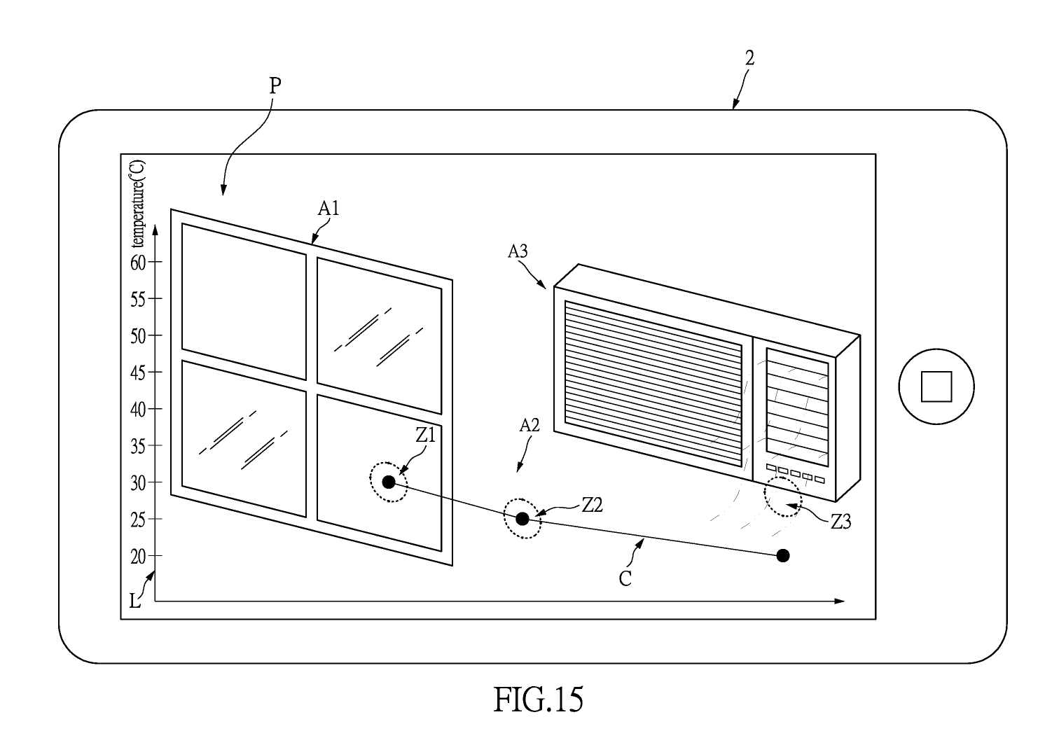

In addition, please refer to FIG. 14 and FIG. 15. FIG. 14 is a flowchart of another thermal detecting method provided by the third embodiment of the instant disclosure, and FIG. 15 is another picture or a scene including a plurality of measurement information presented by the portable electronic device provided by the third embodiment of the instant disclosure.

By comparing FIG. 15 to FIG. 13, it can be seen that the embodiment shown in FIG. 15 can form a picture P (or scene) similar to a thermal imaging map according to the steps above. To be specific, after completing step S208, further performing step S210 including attaching or storing a temperature axis on the picture and corresponding the plurality of measurement information to the temperature axis for presenting a temperature distribution axis corresponding to the plurality of objects respectively. Specifically, a temperature distribution curve C may be formed according to the plurality of measurement information received previously by attaching or storing a temperature axis L on the picture P (or the scene) and the controlling unit 22 of the portable electronic device 2 carrying out a calculation. The temperature axis L may show mark points corresponding to the center of each detecting area (Z1, Z2, Z3) and the temperature axis L (the three points on the temperature distribution curve C in FIG. 14). In other embodiments, the displayed marking light may be removed by an image processing procedure leaving the temperature axis L and the temperature distribution curve C. However, the instant disclosure is not limited thereto.

In addition, although the temperature measuring method of the third embodiment is carried out by moving the temperature measuring device 1 without moving the portable electronic device 2, the temperature measuring device 1 and the portable electronic device 2 may be moved concurrently in other embodiments, and a plurality of images may be connected by performing image processing by the applications in the portable electronic device 2 on the captured images, i.e., the captured images may be connected with each other by the panorama mode in the camera module of the portable electronic device 2.

In addition, if the marking light 141 is a flickering marking light 141, during the flickering (the marking light 141 is on and off under a predetermined frequency), the image capturing unit 23 will capture the image I continuously, i.e., the image capturing unit 23 may capture the object A having the marking light 141 projected thereon and the object A without the marking light 141 at the same position. The above means is benefit to the follow-up image processing procedure. In other words, in other embodiments, the controlling unit 22 may select the image without the marking light 141 projected on the object A and hence, there is no marking light 141 being displayed in FIG. 15. However, the instant disclosure is not limited thereto. Alternatively, the marking light 141 projected on the object A may be removed by the controlling unit 22.

### [Effectiveness of the Embodiments]

In summary, the thermal detecting system S and the thermal detecting method provided by the embodiments of the instant disclosure utilizes the signal connection in wired or wireless form between the temperature measuring device 1 and the portable electronic device 2 and hence, the measurement information detected by the temperature measuring device 1 may be transmitted to the portable device 2. Furthermore, by capturing the image I of the measured object A by the imaging capturing unit 23 in the portable device 2 and overlapping the image I and the measurement information by the portable device 2, the picture P (or a scene) is able to be presented including both the measurement information and the image I. In addition, by performing the image synthesis technique, a plurality of images (I1, I2, I3) is able to be combined, including a plurality of measurement information into a picture P (or a scene) to obtain a picture including the measurement information of each object (A1, A2, A3). A temperature distribution curve may be present at the same time.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

1. A thermal detecting method, comprising:
measuring the temperature of an object by a temperature measuring device for obtaining a measurement information of the object;
capturing the object by a portable electronic device for obtaining an image of the object;
transmitting the measurement information to the portable electronic device; and
attaching or storing the measurement information to the image;
wherein the portable electronic device is a smart phone or a tablet, and the image capturing unit is a camera module in the portable electronic device.

2. The thermal detecting method according to claim 1, wherein in the step of attaching or storing the measurement information to the image, the measurement information of the object is displayed on the image for presenting a picture or a scene including the measurement information and the image.

3. The thermal detecting method according to claim 1, wherein the temperature measuring device includes a laser unit for emitting a laser light aiming or surrounding the object.

4. The thermal detecting method according to claim 3, wherein the measurement information is displayed in the image and the measurement information is positioned adjacent to the laser light or the object.

5. The thermal detecting method according to claim 1, wherein the portable electronic device includes a signal transmitting unit, a controlling unit electrically connected to the signal transmitting unit and an image capturing unit electrically connected to the controlling unit, wherein the temperature measuring device includes a temperature measuring unit, a processing unit electrically connected to the temperature measuring unit, a moisture sensing unit electrically connected to the processing unit and a measurement information transmitting unit electrically connected to the processing unit, wherein the measurement information includes a temperature measurement value, a dry bulb temperature, a wet bulb temperature, a dew point temperature value or a relative moisture value.

6. The thermal detecting method according to claim 5, wherein the temperature measuring unit measures the object for obtaining the measurement information, wherein the measurement information transmitting unit transmits the measurement information to the controlling unit of the portable electronic device, wherein the image is captured by the image capturing unit of the portable electronic device.

7. The thermal detecting method according to claim 1, wherein the step of measuring the temperature of an object by a temperature measuring device and the step of capturing the object by a portable electronic device are performed concurrently.

8. A thermal detecting method, comprising:
sequentially measuring the temperatures of a plurality of objects by moving a temperature measuring device for obtaining a plurality of measurement information of the plurality of objects respectively, and simultaneously emitting a marking light aiming or surrounding the objects for sequentially targeting the plurality of objects;
driving a portable electronic device to timingly and continuously capture an image including the plurality of objects for obtaining a plurality of images;
transmitting a plurality of measurement information to the portable electronic device;
attaching or storing a plurality of measurement information to the plurality of images respectively; and
compositing the plurality of images for presenting a picture or a scene including the plurality of measurement information;
wherein the portable electronic device is a smart phone or a tablet, and the image capturing unit is a camera module in the portable electronic device.

9. The thermal detecting method according to claim 8, wherein the plurality of measurement information is displayed in the picture or the scene, and the plurality of measurement information is displayed adjacent to or on the corresponding laser light or the corresponding object respectively.

10. The thermal detecting method according to claim 8, after the step of combining the plurality of images for presenting a picture or a scene including the plurality of measurement information, further comprising attaching or storing a temperature axis on the picture and corresponding the plurality of measurement information to the temperature axis respectively for presenting a temperature distribution curve corresponding to the plurality of objects.

11. The thermal detecting method according to claim 8, wherein the step of sequentially measuring the temperatures of a plurality of objects by moving a temperature measuring device for obtaining a plurality of measurement information of the plurality of objects respectively, and simultaneously emitting a marking light aiming or surrounding the objects for sequentially targeting the plurality of objects, and the step of driving a portable electronic device to timingly and continuously capturing an image including the plurality of objects for obtaining a plurality of images are performed concurrently.

12. The thermal detecting method according to claim 8, wherein the portable electronic device includes a signal transmitting unit, a controlling unit electrically connected to the signal transmitting unit and an image capturing unit electrically connected to the controlling unit, wherein the temperature measuring device includes a temperature measuring unit, a processing unit electrically connected to the temperature measuring unit, a moisture sensing unit electrically connected to the processing unit and a measurement information transmitting unit electrically connected to the processing unit, wherein the measurement information includes a temperature measurement value, a dry bulb temperature, a wet bulb temperature, a dew point temperature value or a relative moisture value.

13. The thermal detecting method according to claim 12, wherein the temperature measuring unit measures the objects for obtaining the measurement information, wherein the measurement information transmitting unit transmits the measurement information to the controlling unit of the portable electronic device, wherein the images is-are captured by the image capturing unit of the portable electronic device.

14. A thermal detecting system, comprising:
a temperature measuring device, the temperature measuring device includes a temperature measuring unit, a processing unit electrically connected to the temperature measuring unit and a measurement information transmitting unit electrically connected to the processing unit; and
a portable electronic device, the portable electronic device is electronically connected to the temperature measuring device through wire or wireless connection, the portable electronic device includes a signal transmitting unit, a controlling unit electrically connected to the signal transmitting unit and an image capturing unit electrically connected to the controlling unit;
wherein the temperature measuring unit measures the temperature of an object for providing a signal measurement value to the processing unit to output a measurement information corresponding to the signal measurement value, the measurement information is transmitted to the signal transmitting unit through the measurement information transmitting unit;
wherein the image capturing unit captures an image including the object, the controlling unit attaches the measurement information of the object on the image for forming a picture or a scene including the measurement information of the object;
wherein the portable electronic device is a smart phone or a tablet, and the image capturing unit is a camera module in the portable electronic device.
